(19) United States
(12) Patent Application Publication
(10) Pub. No.: US 2024/0334200 A1
(43) Pub. Date: Oct. 3, 2024

(54) SYSTEM AND METHOD FOR ENABLING INTERWORKING IN SELF ORGANIZING NETWORKS

(71) Applicant: JIO PLATFORMS LIMITED, Ahmedabad (IN)

(72) Inventors: Satish Nanjunda Swamy JAMADAGNI, Bangalore (IN); Mahesh Nayaka Mysore Nayaka Mysore ANNAIAH, Bangalore (IN); Mathew OOMMEN, Mumbai (IN)

(73) Assignee: JIO PLATFORMS LIMITED, Ahmedabad (IN)

(21) Appl. No.: 18/579,282

(22) PCT Filed: May 31, 2023
(86) PCT No.: PCT/IB2023/055560

§ 371 Date: Jan. 12, 2024

(30) Foreign Application Priority Data
May 31, 2022 (IN) 202221031238

(51) Int. Cl. H04W 16/32; H04W 84/18

(52) U.S. Cl. CPC H04W 16/32; H04W 84/18

(57) ABSTRACT

The present disclosure provides a system and method for enabling interworking in heterogeneous network (HetNET) with self-organizing networks (SONs). The method includes sending a SON capability query to one or more entities in the HetNet, receiving a SON capability information associated with the one or more entities in the HetNet in response to the SON capability query, and generating an initial SON configuration associated with the one or more entities based on the received SON capability information.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF DISCLOSURE

The embodiments of the present disclosure generally relate to communication networks. In particular, the present disclosure relates to techniques for achieving interoperability in self-organizing networks (SONs).

### BACKGROUND OF DISCLOSURE

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Evolution in cellular network, for example, from fourth generation (4G) to fifth generation (5G) and then to the sixth generation (6G) along with the evolution of other radio access technologies such as wireless fidelity (Wi-Fi) is creating an exponentially increasing subscription for network services subscriptions, forcing mobile operators to deploy very high-density heterogeneous networks (HetNets) to fulfil the demands of subscribers. The HetNets are generally built by Multi-Portfolio and Multi-Vendor based solutions.

The key challenges that the operator(s) face during greenfield or brownfield deployments of the HetNets is the demand for high quality installations that covers:
1. Continuous monitoring of performance and health of the deployed networks.
2. Dynamically adapting to changing environments.
3. Proactive adjustments and optimization.

These challenges lead to huge operational expenses (OPEX). To overcome these deficiencies and to drastically reduce the OPEX, network providers came up with self-organizing networks (SONs).

SON is an automation technology that enables the network to set itself up and self-manage resources and configuration to achieve optimal performance.

SON performs its role under the following categories:

I. Self-Configuration: Aids in seamlessly integrating into the network through automatic configuration of key parameters. It is most valuable during initial network deployments. It includes the following capabilities:
1. Plug-and-Play functionalities.
2. Automatic Neighbor Relation function.
3. Physical layer cell identity (PCI) selection and conflict resolution functions.
   II. Self-Optimization: Aids in enhanced network performance through near real time optimization of radio and network configurations. It is valuable throughout the lifetime of the network. It includes the following capabilities:
1. Mobility Load Balancing.
2. Mobility Robustness Optimization.
3. Random access channel (RACH) Optimization.
4. Energy saving.
5. Radio Link Failure Reporting.
6. Coverage and Capacity Optimization (down link (DL) Power control, remote electric tilt (RET)).
7. Forward Handover.
8. Frequent Handover Mitigation.
9. Interference Mitigation (Inter-Cell, Intra-Cell, Intra-radio access technology (RAT), Inter-RAT), etc.
   III. Self-Healing: It allows adjacent cells to maintain network quality in case a cell/sector fails, providing resiliency (reliability) in the face of unforeseen outage conditions. It is valuable throughout the lifetime of the network. It includes the following capabilities:
1. Cell Outage Detection [Dead/Sick/Sleeping cell/sector/beam].
2. Cell Outage Recovery.
3. Cell Outage Compensation.
4. Cell Outage Compensation Recovery.

The above SON functions are handled by SON algorithms either individually or in groups. SON algorithms perform the functionalities like monitoring the network(s) by collecting management data including management data analytics service (MDAS) data, analysis of the management data to determine if there are issues in the network(s) that need to be resolved, decision on the SON actions to resolve the issues, execution the SON actions, and evaluation of whether the issues have been solved by analyzing the management data.

Further, based on the location of the SON algorithm, SON is categorized broadly into four different solutions that are possible for implementing various SON use cases, the solution is selected depending on the needs of the SON use cases.
1. Centralized SON (C-SON): It means that the SON algorithm executes in the management system.
2. Cross Domain-Centralized SON (CD C-SON): Here, the SON algorithms execute in the Cross-Domain layer.
3. Domain-Centralized SON (D C-SON): Here, the SON algorithm executes in the Domain layer.
4. Distributed SON (D-SON): Here, the SON algorithms are in the NFs.
5. Hybrid SON (H-SON): Here, the SON algorithms are executed at two or more levels like NF layer, Domain layer, or Cross Domain layer.
   Since the SON algorithms are left to implementation, different vendors may choose different approaches for their SON solutions. Some vendors may come up with C-SON approach, some with D-SON approach, and others with H-SON approach-based solutions.

It is inevitable for the mobile network operators to use multi-vendor solutions while deploying HetNets. FIG. 1A illustrates a typical 5G HetNet deployment scenario associated with a mobile operator. The mobile operator may use the management entities like network management system (NMS) from a different vendor, set of element management systems (EMSs) from a different set of vendors, radio access network (RAN) nodes like next generation node B (gNBs) from different set of vendors, of which gNB-Central unit (CUs) may be from a first set of vendors and gNB-distributed units (DUs) may be from a second set of vendors. Few issues that the network operator may face in the above illustrated deployed HetNet are as follows:
i. D-SON of gNB-CU-1 (110-1) and gNB-CU-2 (110-2) may not coordinate well as both are from different vendors, though they communicate each other via open Xn interface.
ii. D-SON of gNB-CU-2 (110-2) and the Hybrid SON of gNB-CU-n (110-N) may not coordinate well as both are from different vendors, though they communicate each other via open Xn interface.
iii. C-SON can be realized as either collocated with management entities [Like EMS/NMS] or as a standalone entity. However, integrating the C-SON as a standalone entity with RAN nodes may require a lot more effort.
iv. CD C-SON (106) in the NMS (104) may impact the performance of the D C-SON and D-SON functionalities, operating in the Multivendor environment.
v. Integrating the third party SON solutions partially in the HetNet, leads to degradation of the overall KPIs.
vi. L3-RRM coordination across the neighbor gNB-CUs (110-1, 110-2 . . . , 110-N) may be lacking irrespective of the same or multivendor scenario, impacting the overall KPI performance.
vii. L3-RRM and L2-RRM coordination across the multi-vendor gNB-CU (110-1) and gNB-DU (112-1) may impact the dynamic resource sharing and allocation.
viii. Proprietary SON and RRM implementations have significant impact on the overall performance since each algorithm behaves differently and have their own pros and cons.

In the above discussed scenario, even if the vendors are ready to integrate with the third-party solutions [SON and/or RRM], they may not be able to deterministically quantify/confirm the output performance as to which vendor's solution is incompatible leading to clash between the agreed vendors.

One possible solution to resolve these issues or limitations is to make the interface between SON solutions and the interacting RAN nodes, to be open interface as much as possible. FIG. 1B illustrates a possible solution as proposed by open radio access network (O-RAN) alliance. Referring to FIG. 1B, the O-RAN architecture may include logical blocks which includes Near-Real Time (RT) RAN Intelligent controller (RIC) (118), an Open radio access network Central Unit Control Plane (O-CU-CP) (122), an Open radio access network Central Unit User Plane (O-CU-UP) (124), an Open radio access network

Distributed Unit (O-DU) (126), and an Open radio access network Radio Unit O-RU functions (128). The E2 interface connects O-CNB (120) to Near-RT RIC (118). Further, an O-cNB (120) may support O-DU and O-RU functions with an Open Fronthaul interface (134) between them. The management side includes Service Management and Orchestration (SMO) (114) Framework containing a Non-RT-RIC (116) function. The O-Cloud (132), on the other hand, may include a cloud computing platform comprising a collection of physical infrastructure nodes that meet O-RAN requirements to host the relevant O-RAN functions (such as Near-RT RIC, O-CU-CP, O-CU-UP and O-DU etc.), the supporting software components (such as Operating System, Virtual Machine Monitor, Container Runtime, etc.) and the appropriate management and orchestration functions. As shown in FIG. 2B, the O-RU (128) terminates the Open Fronthaul M-Plane (134) interface towards the O-DU (126) and SMO (114).

With the explosion of the cellular HetNet deployment, there may a huge demand for the deployment of the Wi-Fi Access Points [AP], to fulfil the huge data throughput requirements. As a result, the network operator may be forced to use multivendor solutions to deploy in its network for the scenarios like carrier grade Wi-Fi, enterprise Wi-Fi. Mi-Fi, Home Wi-Fi, and the like. Further, the above discussions related to FIGS. 1A and 1B, do not provide clearly defined techniques to implement at the HetNet based on be O-RAN to avoid conflicts arising from multi-vendor solutions.

There is, therefore, a need in the art to provide interoperability solutions between multiple vendor functions that can overcome the shortcomings of the existing prior arts.

### OBJECTS OF THE PRESENT DISCLOSURE

Some of the objects of the present disclosure, which at least one embodiment herein satisfies are as listed herein below.

It is an object of the present disclosure to provide realization of self-organizing network (SON) functionalities in some locations of 4G/5G heterogeneous network (HetNet) architecture.

It is another object of the present disclosure to provide a functional execution split localization of SON functionality at a service management and orchestration (SMO) framework.

It is another object of the present disclosure to provide the functional execution split either at management entity and/or Non-real time RAN intelligent controller (non-RT RIC) entities, Near RT-RIC, E2 Nodes of the open radio access network (O-RAN) architecture.

It is yet another object of the present disclosure to provide specific mechanisms of data collection to address the said functionalities of SON in an O-RAN architecture.

It is yet another object of the present disclosure to provide discovery of the mutual SON function implementations across the HetNet.

It is yet another object of the present disclosure to provide interworking aspects within an SON function.

It is yet another object of the present disclosure to provide interworking aspects across SON functions.

It is yet another object of the present disclosure to improvise the communication system.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for enabling interoperability of self-organizing networks (SONs) in a heterogeneous network (HetNet). The system includes one or more processors and a memory operatively coupled to the one or more processors, wherein the memory comprises processor-executable instructions, which on execution, cause the one or more processors to: send a SON capability query to one or more entities in the HetNet, receive a SON capability information associated with the one or more entities in the HetNet in response to the SON capability query, and generate an initial SON configuration associated with the one or more entities based on the received SON capability information.

In some embodiments, the system is configured to command the one or more entities in the HetNet to enable/disable the SON function in the one or more entities based on the received SON capability information, wherein the one or more entities comprise open radio access network (O-RAN) entities.

In some embodiments, the system includes a non-real time radio access network intelligent controller (non-RT RIC), a near-RT RIC, and an E2 node. In some embodiments, the SON capability information comprises an SON support bitmap information element (IE). The system is configured to create a SON support matrix based on the SON support bitmap IE received from the one or more entities; and generate the initial SON configuration based on the SON support matrix.

In one or more embodiments, the system is configured to collect analytics data associated with the HetNet, detect one or more events in the HetNet, and generate a dynamic SON configuration associated with the one or more entities based on at least one of the collected data and the detected one or more events.

In some embodiments, the system is configured to operate a first element associated with the SON configuration in a first entity of the one or more entities, operate a second element associated with the SON configuration in a second entity of the one or more entities, detect a change of operation associated with the first element in the first entity, and communicate the change of operation associated with the first element in the first entity to the second element in the second entity. Further, the system is configured to receive a response from the second element in the second entity based on the change of operation associated with the first element in the first entity and execute the change of operation associated with the first element in the first entity based on the received response.

In another aspect, the present disclosure related to a method for enabling interoperability of self-organizing networks (SONs) in a heterogeneous network (HetNet). The method include sending, by one or more processors, a SON capability query to one or more entities in the HetNet, receiving, by the one or more processors, a SON capability information associated with the one or more entities in the HetNet in response to the SON capability query and generating, by the one or more processors, an initial SON configuration based on the received SON capability information.

In some embodiments, the method includes commanding, by the one or more processors, the one or more entities in the HetNet to enable/disable the SON function in the one or more entities based on the received SON capability information, wherein the one or more entities comprises open radio access network (O-RAN) entities. In an embodiment the one or more entities comprises at least one of a non-real time radio access network intelligent controller (non-RT RIC), a near-RT RIC, and a E2 node and the SON capability information comprises a SON support bitmap information element (IE).

In some embodiments, the method includes creating, by the one or more processors, a SON support matrix based on the SON support bitmap IE from the one or more entities and generating, by the one or more processors, the initial SON configuration based on the SON support matrix. Further, the method includes collecting, by the one or more processors, analytics data associated with the HetNet, detecting, by the one or more processors, one or more events in the HetNet and generating, by the one or more processors, a dynamic SON configuration associated with the one or more entities based on at least one of the collected data and the detected events.

In some embodiments, the method includes operating, by the one or more processors, a first element associated with the SON configuration in a first entity of the one or more entities, operating, by the one or more processors, a second element associated with the SON configuration in a second entity of the one or more entities, detecting, by the one or more processors, a change of operation associated with the first element in the first entity, and communicating, by the one or more processors, the change of operation associated with the first element in the first entity to the second element in the second entity. Further, the method includes receiving, by the one or more processors, a response from the second element in the second entity based on the change of operation associated with the first element in the first entity and executing, by the one or more processors, the change of operation associated with the first element in the first entity based on the received response.

In yet another aspect, the present disclosure relates to a user equipment (UE) operating in a heterogenous network (HetNet). The UE includes one or more processors communicatively coupled to a system, wherein the system comprises one or more processors and a memory operatively coupled to the one or more processors, wherein the memory comprises processor-executable instructions, which when executed by the one or more processors, cause the one or more processors to send a self-organizing network (SON) capability query to one or more entities in the HetNet, receive a SON capability information associated with the one or more entities in the HetNet in response to the SON capability query and generate an initial SON configuration associated with the one or more entities based on the received SON capability information.

In yet another aspect, the present disclosure relates to a non-transitory computer readable medium comprising one or more instructions stored thereupon that when executed by a processor cause the processor to send a self-organizing network (SON) capability query to one or more entities in the HetNet, receive a SON capability information associated with the one or more entities in the HetNet in response to the SON capability query and generate an initial SON configuration associated with the one or more entities based on the received SON capability information.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components or circuitry commonly used to implement such components.

FIG. 1A illustrates an exemplary architecture (100-1) representing an existing conventional fifth generation (5G) heterogeneous network (HetNet) deployment.

FIG. 1B illustrates a standard open radio access network architecture (100-B).

FIG. 2 illustrates an exemplary network architecture (200) in which or with which a system of the present disclosure may be implemented for enabling interworking of self-organizing network (SON), in accordance with an embodiment of the present disclosure.

FIG. 3 illustrates an exemplary block diagram representation (300) of a controller for enabling interworking of self-organizing network (SON), in accordance with an embodiment of the present disclosure.

FIG. 4A illustrates an exemplary message flow (400-A) for discovery and handshake mechanism with a Service Management and Orchestration (SMO) entity as a master, in accordance with an embodiment of the present disclosure.

FIG. 4B illustrates an exemplary message flow (400-B) for discovery and handshake mechanism with a non-real time radio access network intelligent controller (non-RT RIC) as a master, in accordance with an embodiment of the present disclosure.

FIG. 4C illustrates an exemplary message flow (400-C) for discovery and handshake mechanism with a near-RT RIC as a master, in accordance with an embodiment of the present disclosure.

FIG. 5 illustrates a table (500) representing various deployment options for enabling interworking of the SON function across distinct nodes, in accordance with an embodiment of the present disclosure.

FIG. 6A illustrates a first deployment scenario (600-A) where SON algorithms are supported in management entities of the SMO, in accordance with an embodiment of the present disclosure.

FIG. 6B illustrates a second deployment scenario (600-B) where SON algorithms are supported in EMS and a network management system (NMS), in accordance with an embodiment of the present disclosure.

FIG. 6C illustrates a third deployment scenario (600-C) where different SON algorithms are supported in multi-vendor EMS, in accordance with an embodiment of the present disclosure.

FIG. 6D illustrates a SON support bit map information element (IE) (600-D) in accordance with an embodiment of the present disclosure.

FIG. 6E illustrates a SON support matrix (600-E) associated with the deployment scenarios (600-A-600-C), in accordance with an embodiment of the present disclosure.

FIG. 6F illustrates an exemplary sequence flow (600-F) for the SON support in accordance with the first, second and third deployment scenarios (600-A-600-C), in accordance with an embodiment of the present disclosure.

FIG. 7A illustrates an exemplary diagram representing a fourth deployment scenario (700-A) where SON algorithms are supported in anon-RT RIC using O1 interface, in accordance with an embodiment of the present disclosure.

FIG. 7B illustrates an exemplary diagram representing a fifth deployment scenario (700-B) where SON algorithms are supported in a non-RT RIC using A1 and E2 interfaces, in accordance with an embodiment of the present disclosure.

FIG. 7C illustrates a SON support matrix (700-C) associated with the deployment scenarios (700-A-700-B), in accordance with an embodiment of the present disclosure.

FIG. 7D illustrates an exemplary sequence flow (700-D) for the SON support in accordance with the fourth and fifth deployment scenarios (700-A-700-B), in accordance with an embodiment of the present disclosure.

FIG. 8A illustrates an exemplary diagram representing a sixth deployment scenario (800-A) where SON algorithms are supported in both management entity as well as in non-RT RIC using O1 interface, in accordance with an embodiment of the present disclosure.

FIGS. 8B-8D illustrate SON support matrices associate with the deployment scenario (800-A), in accordance with an embodiment of the present disclosure.

FIG. 8E illustrates an exemplary sequence flow (800-E) for the SON support in accordance with the sixth deployment scenario (800-A), in accordance with an embodiment of the present disclosure.

FIG. 9 illustrates an exemplary representation (900) interference in the HetNet due to interaction between multiple SON functions, in accordance with an embodiment of the present disclosure.

FIG. 10 illustrates an exemplary computer system (1000) in which or with which embodiments of the present invention can be utilized in accordance with embodiments of the present disclosure

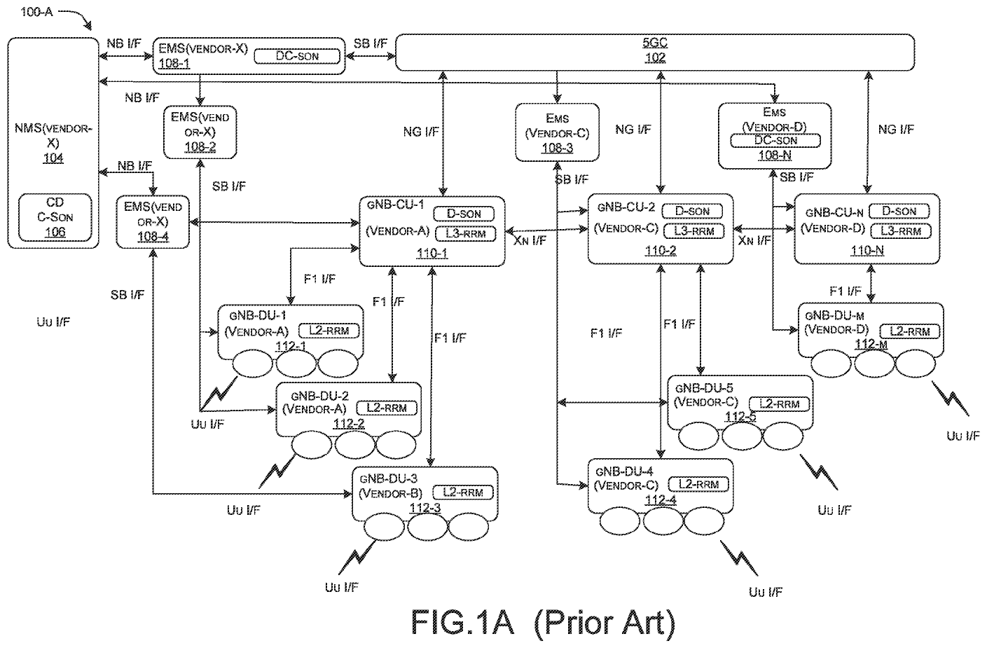

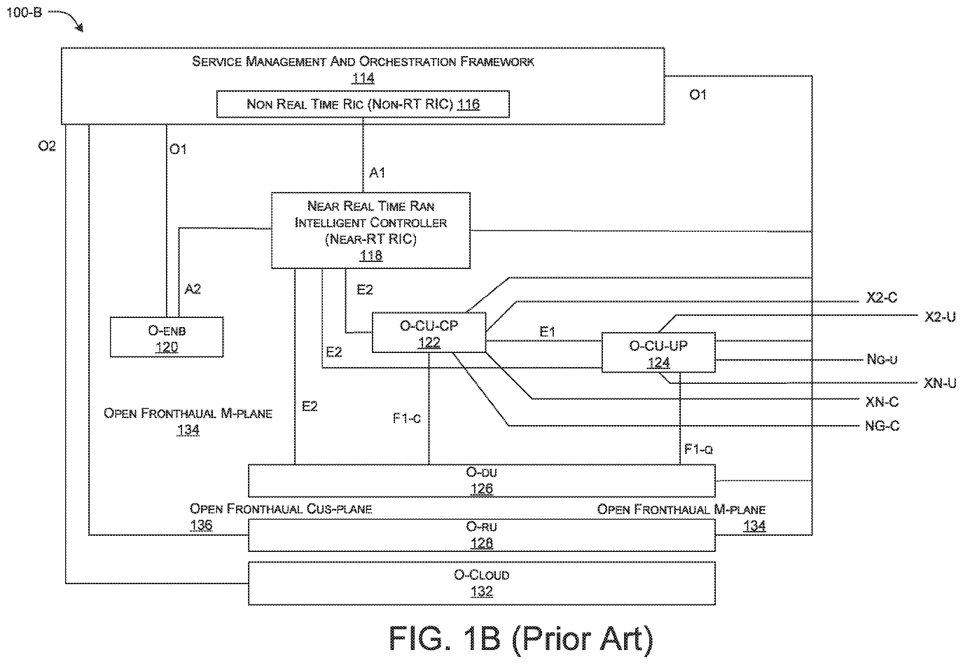

The foregoing shall be more apparent from the following more detailed description of the disclosure.

### DETAILED DESCRIPTION OF DISCLOSURE

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Certain terms and phrases have been used throughout the disclosure and will have the following meanings in the context of the ongoing disclosure.

The term “HetNet” may refer to a heterogeneous network comprising one or more components of 4G/5G/6G network.

The term “SON” may refer to self-organizing networks that are radio access networks (RANs) that can automatically plan, configure, manage, optimize, and heal themselves.

The term “MRO” may refer to mobility robustness optimization performing automated optimization of parameters affecting active mode and idle mode handovers.

The term “MLB” may refer to mobility load balancing where cells suffering congestion can transfer load to other cells having spare resources.

The term “SMO” may refer to service management and orchestration (SMO) providing an automation platform for open RAN radio resources.

The term “Non-RT-RIC” may refer to non-real time RAN intelligent controller. The non-RT RIC is a part of the SMO Framework, centrally deployed in a service provider network and enables non-real-time (>1 second) control of RAN elements and their resources through specialized applications called rApps.

The term “Near RT-RIC” may refer to near real time RAN intelligent controller responsible for intelligent edge control of RAN nodes and resources. The near-RT RIC controls RAN elements and their resources with optimization actions that typically take 10 milliseconds to one second to complete.

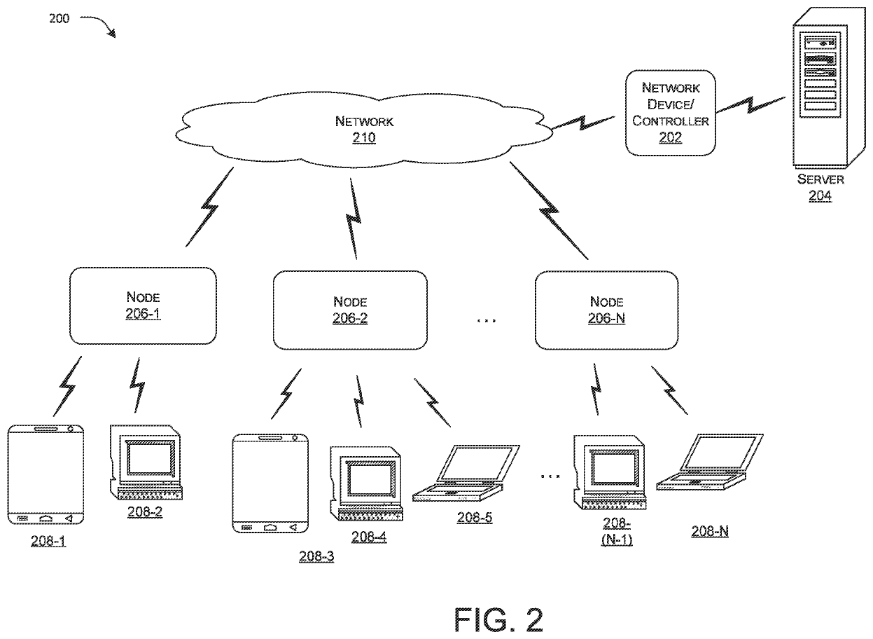

The various embodiments throughout the disclosure will be explained in more detail with reference to FIGS. 2-10.

In an aspect the present disclosure provides a robust and effective solution for implementing SON functions in O-RAN entities such as Near Real Time RIC and non-Real Time RIC.

FIG. 2 illustrates an exemplary network architecture (200) in which or with which embodiments of the present disclosure may be implemented.

Referring to FIG. 2, the network (200) may include a network device (202) capable of implementing functions of a network management system (NMS) or an element management system (EMS) and may be coupled with a plurality of nodes (206-1, 206-2, . . . 206-N) such that the network device (202) may be configured to facilitate communication through self-organizing network (SON) among the plurality of nodes (collectively referred to as nodes 206, and individually referred to as node 206, hereinafter). In some embodiments, the nodes (206) may include such as without limitations, a next generation node B (gNB), an evolved node B (eNodeB), a gNB-central unit (gNB-CU), and a gNB-distributed unit (gNB-DU) providing communication services to one or more user equipments or computing devices or user devices (208-1, 208-2, . . . 208-N) (collectively referred to as user devices 208, and individually referred to as user device 208, hereinafter).

Referring to the architecture (200), in some embodiments a communication channel may be established by enabling interworking of SON between user devices (208) associated with distinct nodes (206), for example, a communication may be established between a second user device (208-2) associated with a first node (206-1) and a nth user device (208-N) associated with a nth node (206-N).

In another embodiment, a communication channel maybe established by enabling interworking of SON between user devices (208) associated with the same node, for example, a communication may be established between a first user device (208-1) and the second user device (208-2) associated with the first node (206-1).

Referring to FIG. 2, the network device (202) may include a network controller and may be configured as an application server and may be communicably operational or may be integrated with a user device (208) via a network (210). In some embodiments the controller (202) may be coupled with a server (204). The server (204) may be a centralized server for storing and processing data related to user devices (208).

In another exemplary embodiment, the user device (208) may include a wireless device. The wireless device may be a mobile device that may include, for example, cellular telephone, such as a feature phone or smartphone and other devices. The user device (208) may not be limited to the above mentioned devices, but may include any type of device capable of providing wireless communication, such as a cellular phone, a tablet computer, a personal digital assistant (PDA), a personal computer (PC), a laptop computer, a media centre, a work station and other such devices.

Referring to FIG. 2, in some embodiments, the network (210) may be a next-generation network that may include at least one of a wireless network, a wired network or a combination thereof. The network (210) may be implemented as one of the different types of networks, such as Intranet, Local Area Network (LAN), Wide Area Network (WAN), Internet, and the like. Further, the network (210) can either be a dedicated network or a shared network. The shared network can represent an association of the different types of networks that can use a variety of protocols, for example, Hypertext Transfer Protocol (HTTP), Transmission Control Protocol/Internet Protocol (TCP/IP), Wireless Application Protocol (WAP), Automatic repeat request (ARQ), and the like. In an embodiment, the network (210) may pertain to a next-generation network that may be facilitated through, for example, Global System for Mobile communication (GSM) network; a universal terrestrial radio network (UTRAN), an Enhanced Data rates for GSM Evolution (EDGE) radio access network (GERAN), an evolved universal terrestrial radio access network (E-UTRAN), a WIFI or other LAN access network, or a satellite or terrestrial wide-area access network such as a wireless microwave access (WIMAX) network. In an example embodiment, the communication network may enable next-generation network based on subscription pertaining to the user/user device and/or through a Subscriber Identity Module (SIM) card. Various other types of communication network or service may be possible.

By way of example, without limitations, the network (210) may utilize different sort of air interface, such as a code division multiple access (CDMA), time division multiple access (TDMA), or frequency division multiple access (FDMA) air interface and other implementation. In an example embodiment, the wire-line user device may use wired access networks, exclusively or in combination with wireless access networks, for example, including Plain Old Telephone Service (POTS), Public Switched Telephone Network (PSTN), Asynchronous Transfer Mode (ATM), and other network technologies configured to transport Internet Protocol (IP) packets.

A person of ordinary skill in the art will appreciate that the exemplary network architecture (200) may be modular and flexible to accommodate any kind of changes.

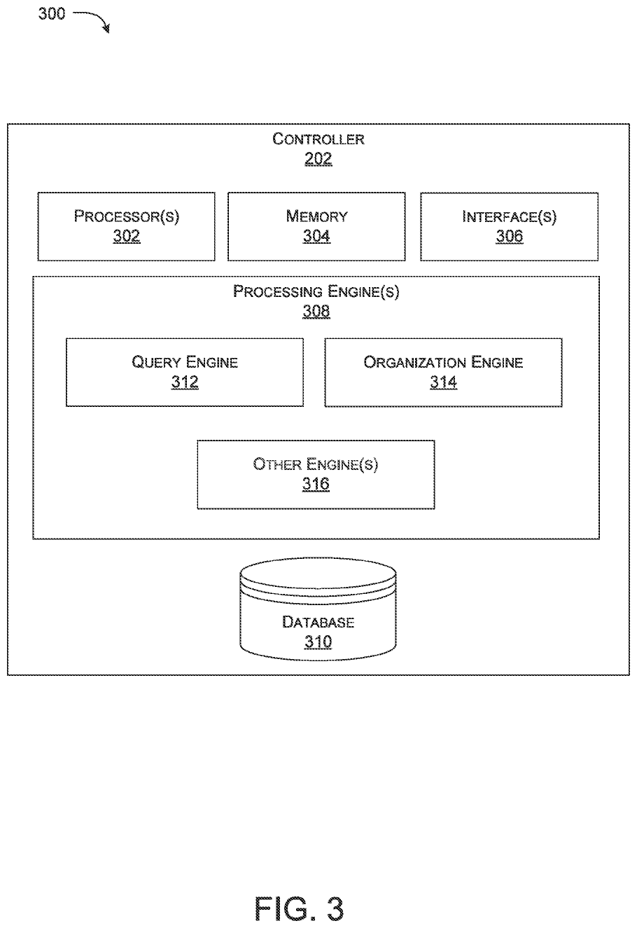

FIG. 3 illustrates an exemplary block diagram representation (300) of a network node or a controller (202) for enabling interworking of self-organizing network (SON), in accordance with an embodiment of the present disclosure.

Referring to FIG. 3, an example architecture of the controller (202) is shown. The controller (202) may facilitate interworking of self-organizing networks by a combination of hardware and software implementation. In some embodiments, the controller may include the SMO, the non-RT RIC, and the near RT-RIC. The controller (202) may include one or more processors (302). The one or more processor(s) (302) may be coupled with a memory (304). The memory (304) may store instructions those when executed by the one or more processors (302) may cause the controller (202) to perform the steps as described herein.

In an example embodiment, if multiple pre-defined criteria may be considered, the processor(s) (302) may be able to prioritize the pre-defined criteria to enable efficient configuration and organization of the associated networks. Various other embodiments may be possible. The pre-defined criteria may include a SON capability bit map information element (IE).

Referring to FIG. 3, the processor(s) (302) may be implemented as one or more microprocessors, microcomputers, microcontrollers, digital signal processors, central processing units, logic circuitries, and/or any devices that process data based on operational instructions. Among other capabilities, the processor(s) (302) may be configured to fetch and execute computer-readable instructions stored in a memory (304) of the controller (202). The memory (304) may be configured to store one or more computer-readable instructions or routines in a non-transitory computer readable storage medium, which may be fetched and executed to create or share data packets over a network service. The memory (304) may comprise any non-transitory storage device including, for example, volatile memory such as a random access memory (RAM), or non-volatile memory such as erasable programmable read only memory (EPROM), a flash memory, and the like.

In an embodiment, the controller (202) may include an interface(s) (306). The interface(s) (306) may comprise a variety of interfaces, for example, interfaces for data input and output devices, referred to as I/O devices, storage devices, and the like. The interface(s) (306) may facilitate communication of the controller (202). The interface(s) (306) may also provide a communication pathway for one or more components of the controller (202). Examples of such components include, but are not limited to, processing engine(s) or modules (308) and a database (310).

Referring to FIG. 3, the processing engine(s) or modules (308) may be implemented as a combination of hardware and programming (for example, programmable instructions) to implement one or more functionalities of the processing engine(s) or modules (308). In example described herein, such combinations of hardware and programming may be implemented in several different ways. For example, the programming for the processing engine(s) or modules (308) may be processor executable instructions stored on a non-transitory machine-readable storage medium and the hardware for the processing engine(s) or modules (308) may comprise a processing resource (for example, one or more processors), to execute such instructions. In the present examples, the machine-readable storage medium may store instructions that, when executed by the processing resource, implement the processing engine(s) or modules (308). In such examples, the controller (202) may comprise the machine-readable storage medium storing the instructions and the processing resource to execute the instructions, or the machine-readable storage medium may be separate but accessible to the controller (202) and the processing resource. In other examples, the processing engine(s) or modules (308) may be implemented by electronic circuitry.

Further, the processing engine or modules (308) of the controller 202 may include one or more components, as illustrated in the FIG. 3, including a query engine (312), an organizing engine (314), and other engines/modules or components (316). In an embodiment, the query engine (312) may enable a master node to query about the capabilities of other nodes. For example, the capabilities queried may include SON capabilities of the queried node. By way of example, one or more nodes may include the capabilities and other nodes may include limitations.

Referring to FIG. 3, in some embodiments, the organizing engine (314) may command to retain or disable SON function in a particular node based on its capacity and connectivity, thereby enabling interworking and organizing of various networks. Various other functions of the components may be possible. In an embodiment, database (210) may comprise data that may be either stored or generated as a result of functionalities implemented by any of the components of the processing engine(s) (308) of the controller (202).

A person of ordinary skill in the art will appreciate that the exemplary block diagram (300) may be modular and flexible to accommodate any kind of changes in the controller (202). Although FIG. 3 shows exemplary components of the block diagram (300), in other embodiments, the block diagram (300) may include fewer units, different units, differently arranged units, or additional functional units than depicted in FIG. 3. Additionally, or alternatively, one or more units of the controller (202) may perform functions described as being performed by one or more other units of the controller (202).

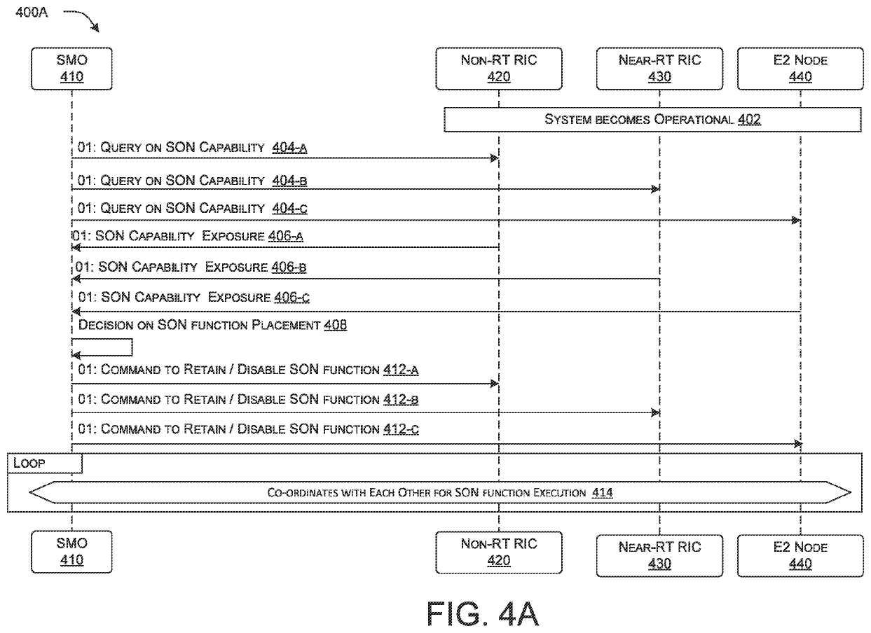

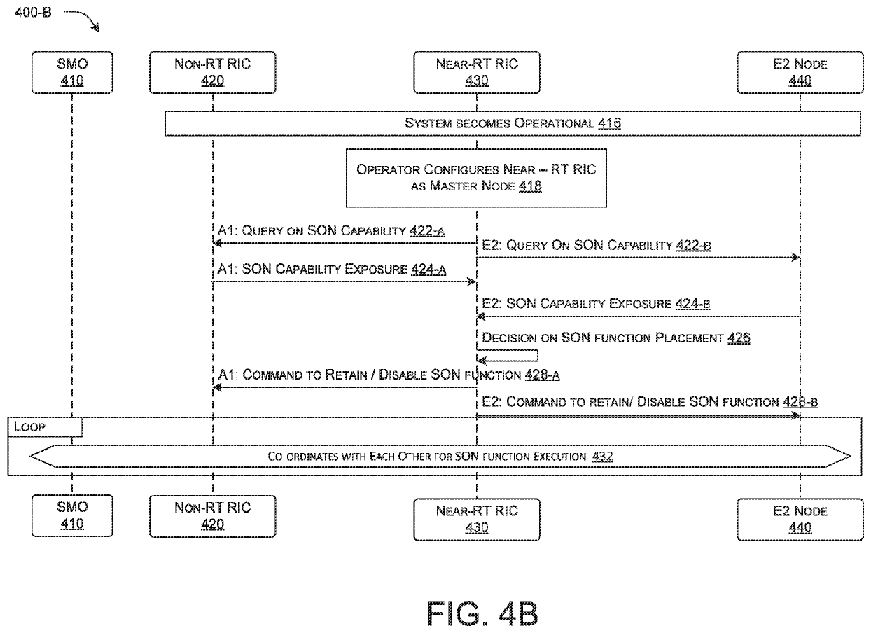

FIG. 4A illustrates an exemplary message flow (400-A) for discovery and handshake mechanism with a Service Management and Orchestration (SMO) entity as a master, in accordance with an embodiment of the present disclosure. In FIG. 4A the different messages related to SON capability query and response is shown.

In accordance with some embodiments, each of the O-RAN functions connected to the SMO (410) via O1 may handle different SON use cases and may have different SON capabilities. These O-RAN function modules-Non-RT RIC (420) and Near-RT RIC (430) needs to expose their SON capabilities to SMO (410) via O1 interface. SMO (410) acts as a Master to co-ordinate the SON capabilities between non-RT RIC (420), Near-RT RIC (430) and E2 Node (440). SMO shall query for the SON capabilities of the Non-RT RIC (420), Near-RT RIC (430) and E2 Node (440) when they are connected to SMO (410) via O1 interface. This is the Discovery function executed by SMO (410) to understand the SON capabilities. Based on the SON capability data from the Non-RT RIC (420), Near-RT RIC (430) and E2 Node (440), the SMO (410) decides the O-RAN function and the SON capabilities the O-RAN function needs to handle. If all the O-RAN functions-Non-RT RIC (420), Near-RT RIC (430) and E2 Node (440) are capable of handling a particular SON function, then based on operator configuration SMO (410) decides whether the conflicting SON capability needs to be handled by either Non-RT RIC (420) or Near-RT RIC (430) or E2 Node (440). SMO (410) communicates the decision on retaining the SON capability to Non-RT RIC (420), Near-RT RIC (430) and E2 Node (440) via O1 interface. Non-RT RIC, Near-RT RIC and E2 Node based on the command from SMO retains or disables a particular SON capability and co-ordinates with the other O-RAN function to achieve smooth interworking of the SON use case across the hierarchy.

Referring to FIG. 4A, initially at step 402, the Non-RT-RIC (420), near RT-RIC (430), and an E2 node (440), are made operational. Once the nodes (420, 430, 440) are operational, the SMO (410) sends a first SON capability query (404-a) to non-RT RIC (420), a second SON capability query (404-b) to near-RT RIC (430), and a third SON capability query (404-c) to E2 node (440). Upon receiving the SON capability query, the non-RT RIC (420), the near-RT RIC (430), and E2 node (440) reply exposing their SON capability (406-a, 406-b, 406-c), respectively. The SMO (410) upon receiving the SON capability information may decide, at step 408, whether to disable or retain SON functionality in non-RT RIC (420), the near-RT RIC (430), and E2 node (440). The SMO (410) sends commands (412-a, 412-b, 412-c) to non-RT RIC (420), the near-RT RIC (430), and E2 node (440), respectively, to either retain or disable SON functionality. Accordingly, the SMO (410), the non-RT RIC (420), the near-RT RIC (430), and the E2 node (440) coordinates, at step 414, with each other for SON function execution. All the above messaging happens through O1 interface.

In some embodiments, based on the operator configuration either Near-RT RIC (430) or Non-RT RIC (420) may act as Master. Non-RT or Near-RT RIC configured as Master shall query the other entities to expose their SON capabilities via O1 interface. When the Master O-RAN function is aware of the SON capabilities of the other O-RAN function connected to it, based on the configuration, master node shall decide the placement of the SON function in the respective O-RAN functions. The Master node shall communicate the decision on the placement of SON function to other O-RAN functions via O1 interface. Based on the command from the Master node, the other O-RAN functions connected to the Master node shall retain or disable the SON capability and co-ordinate with other O-RAN functions for SON functions. FIGS. 4B and 4C as illustrate the scenario of near RT-RIC (430) and non-RT RIC (420) as master nodes and is discussed in the detail below.

FIG. 4B illustrates an exemplary message flow (400-B) for discovery and handshake mechanism with a non-real time radio access network intelligent controller (non-RT RIC) as a master, in accordance with an embodiment of the present disclosure. In FIG. 4B, the different messages related to SON capability query and response with near RT-RIC (430) as master, is shown.

Referring to FIG. 4B, once the system gets operational at step 416, an operator, for example, a mobile network operator, may configure, at step 418, the near-RT RIC (430) as a master node. The near-RT RIC (430) may then perform SON capability query with non-RT RIC (420) and E2 node (440) over A1 and E2 interfaces, respectively. In accordance with some embodiments, the near-RT RIC (430) may send SON capability query (422-a) to non-RT RIC (420) over the A1 interface. Further, the near-RT RIC (430) may send SON capability query (422-b) to E2 node (440) over the E2 interface. The non-RT RIC (420) may send its SON capability (424-a) through the A1 interface to the near-RT RIC (430). Similarly, the E2 node (440) may send its SON capability (424-b) through the E2 interface to the near-RT RIC (430). The near-RT RIC (430) decides at step 426 whether to disable or retain the SON function at non-RT RIC (420) and E2 node (440) and accordingly send a command (428-a) to non-RT RIC (420) and another command (428-b) to E2 node, whether to disable or retain SON function. Further, at step 432, all the nodes (410, 420, 430, 440) coordinates with each other for SON function. In an embodiment, all the communication between near-RT RIC (430) and non-RT RIC (420) is over A1 interface. Similarly, all the communication between near-RT RIC (430) and E2 node (440) is over E2 interface

FIG. 4C illustrates an exemplary message flow (400-C) for discovery and handshake mechanism with a non-RT RIC as a master, in accordance with an embodiment of the present disclosure.

Referring to FIG. 4C, once the system gets operational at step 434, the operator may, at step 436, configure non-RT RIC (420) as a master node. The non-RT RIC (420) may then perform SON capability query with near-RT RIC (430) and E2 node (440). In accordance with some embodiments, the near-RT RIC may be a relay for communication between non-RT RIC (420) and E2 node (440). Referring to FIG. 4C, the non-RT RIC (420) may send SON capability query (438-a) for both the near-RT RIC (430) and the E2 node (440) over the A1 interface to near RT RIC (430). The near-RT RIC (430) relays the SON capability query (438-b) to the E2 node (440) over E2 interface. Further, the near RT RIC (430) may send its SON capability (442-a) through the A1 interface to the non-RT RIC (420). Similarly, the E2 node (440) may send its SON capability (442-b) through the E2 interface to the near-RT RIC (430), which further relays E2's SON capability to the non-RT RIC (420) through the A1 interface. The non-RT RIC (420) decides at step 444 whether to disable or retain the SON function at near-RT RIC (430) and E2 node (440) and accordingly sends a command (446-a) addressing both near-RT RIC (430) and E2 (440) over A1 interface. The near-RT RIC (430) relays the command (446-b) to the E2 node (440) over E2 interface. The command (446-a, 446-b) may include whether to disable or retain SON function. Further, at step 448, all the nodes (410, 420, 430, 440) coordinates with each other for SON function.

The Discovery and Handshake mechanism for SON capabilities as discussed above avoids duplication and conflict of SON functionalities in the O-RAN functions connected to each other. This may enable better interoperability in an environment with O-RAN functions from different vendors with unknown SON capabilities.

In some embodiments, the SON related measurements, configuration parameters and other relevant data are collected by the O-RAN functions to execute SON based decisions. Sometimes the O-RAN functions executing SON function may need SON related data from other O-RAN functions not connected to the same hierarchy. For example, cell A and cell B may be co-located. But Near-RT RIC to which the E2 Nodes are attached may be in a different cell. Hence SON function like MLB or MRO, may need inputs from the neighbouring E2 Node not connected to the same Near-RT or Non-RT RIC. In such a scenario based on the inputs received, the O-RAN function may decide to perform handover or user equipment (UE) release to the neighbouring O-RAN function. In order to facilitate collection of SON relevant data or execute actions based on the SON outcome, the Near-RT RIC or Non-RT RIC exposes SON relevant data or receives commands as SON function outcome. Application program interface (APIs) to external interfaces for fetching of SON relevant data or to execute SON related action may facilitate this scenario.

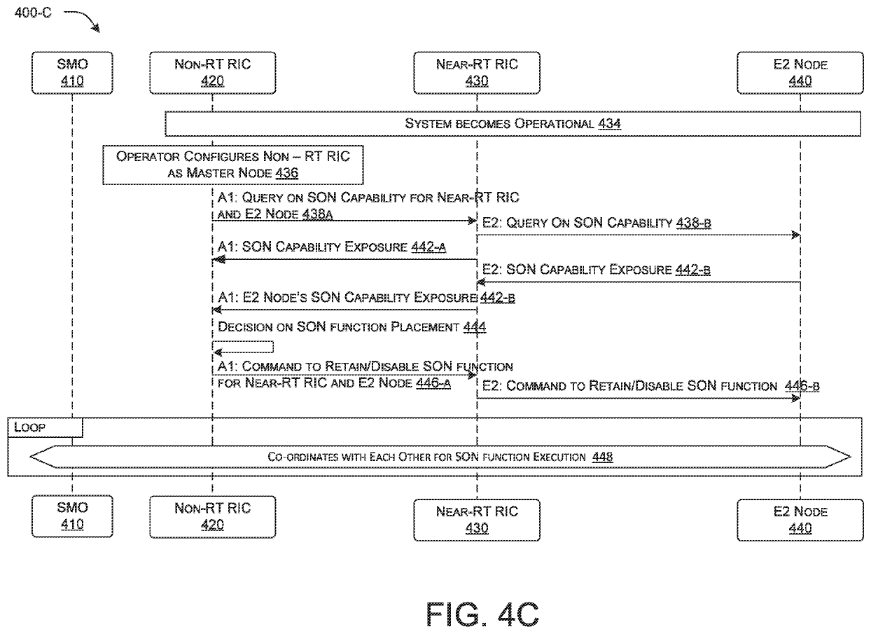

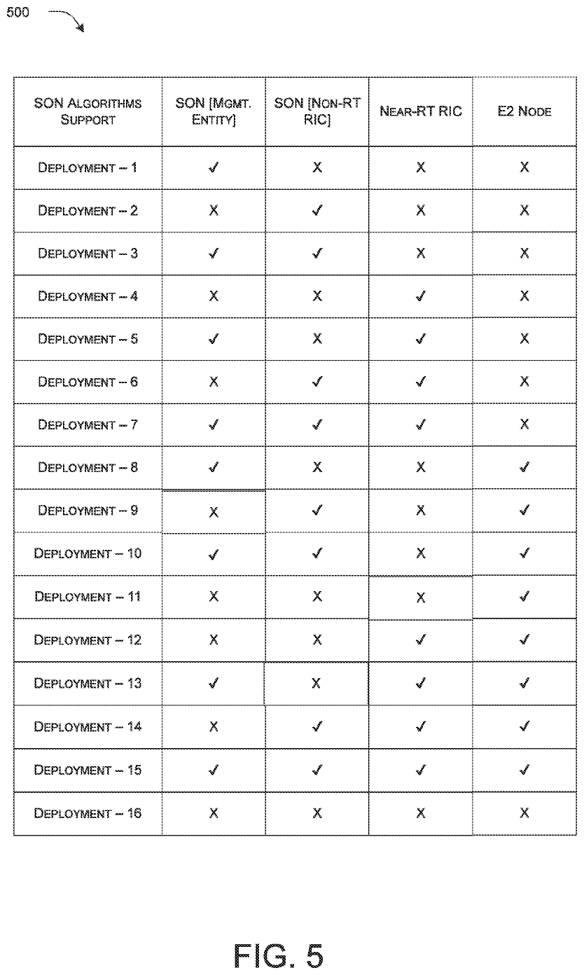

FIG. 5 illustrates a table (500) representing various deployment options for enabling interworking of the SON function across distinct nodes, in accordance with an embodiment of the present disclosure. In one embodiment a system of localization of specific SON functions and algorithms may be realized by implementing any of the deployment scenario as mentioned in FIG. 5. Referring to FIG. 5, there are around sixteen different types of deployment scenarios. In some embodiments, the SON function may be deployed in any one of SMO, non-RT RIC, near-RT RIC or E2 node as mentioned in deployment scenarios 1, 2, 4, and 11, respectively. In some embodiments, the SON function may be deployed in any of the two O-RAN modules for example, SMO and non-RT RIC, SMO and near RT RIC, non-RT and near RT RIC, SMO and E2 node, non-RT RIC and E2 node, and near RT RIC and E2 node, as shown in deployment scenarios 3, 5, 6, 8, 9, and 12. In some other embodiments, the SON function may be deployed in any of the three O-RAN modules, for example, SMO, non-RT RIC, and near-RT RIC, SMO, non-RT RIC and E2 node, SMO, near-RT RIC, and E2 node, and non-RT RIC, near RT RIC, and E2 node, as shown in deployment scenarios 7, 10, 13, and 14. In some embodiments, the SON function may be deployed in all the four O-RAN modules, for example, SMO, near-RT RIC, non-RT RIC, and E2 node as shown in deployment scenario 15. In some embodiments, the SON may not be implemented in any of the O-RAN modules as shown in deployment scenario 16.

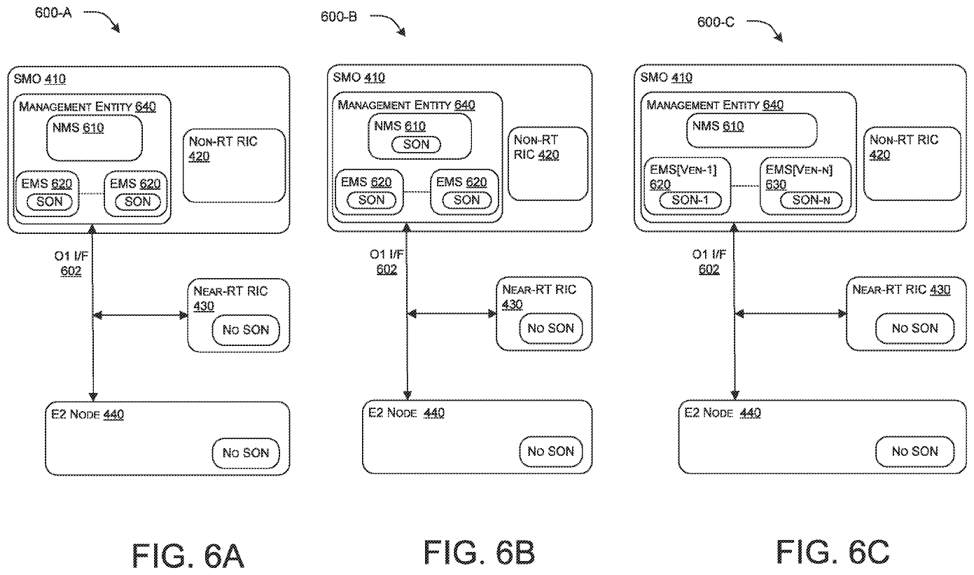

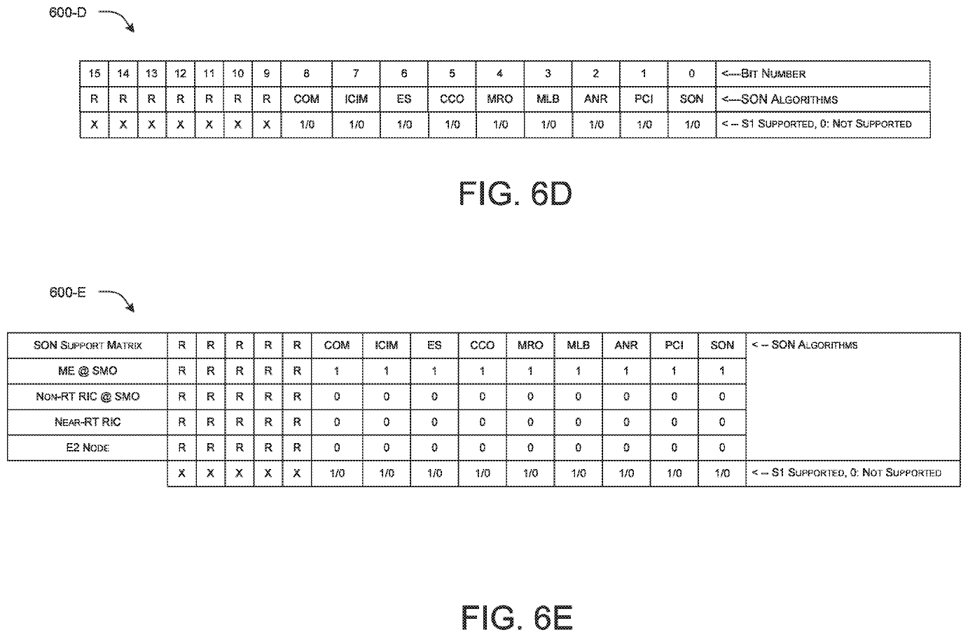

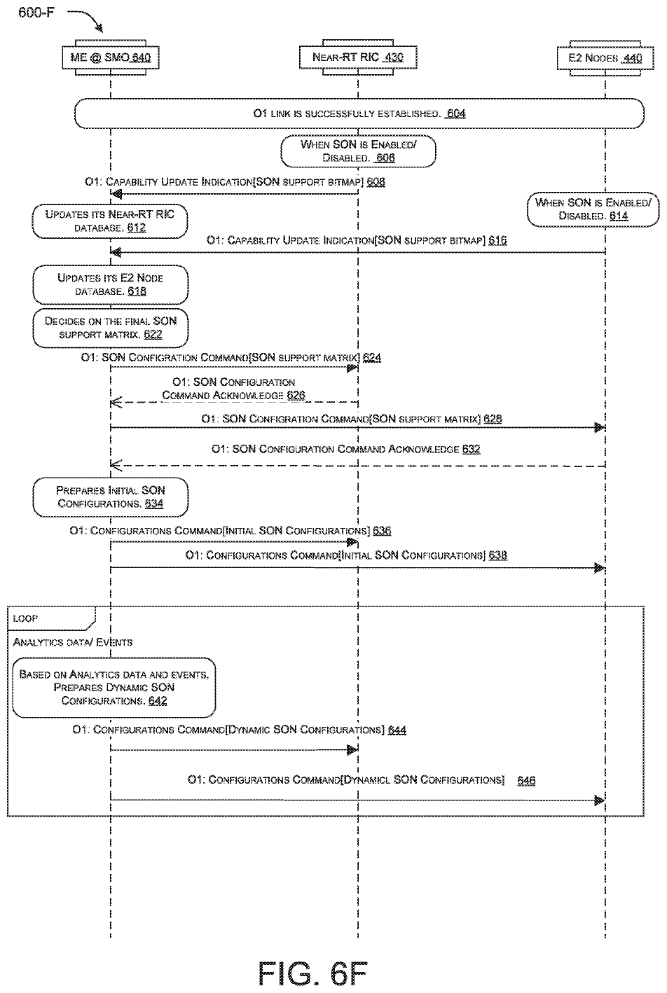

FIG. 6A illustrates a first deployment scenario (600-A) where SON algorithms are supported in management entities of the SMO, in accordance with an embodiment of the present disclosure. In FIG. 6A, implementation of the SON functions in an element management system (EMS) (620) at the SMO (410) is shown. In accordance with some embodiments, the SMO (410) includes one or more management entities (640), for example, network management system (NMS) (610) and EMSes (620). In one exemplary embodiment, the SON algorithm is supported at EMSes (620) of the SMO (410).

FIG. 6B illustrates a second deployment scenario (600-B) where SON algorithms are supported in EMS and a network management system (NMS), in accordance with an embodiment of the present disclosure. In FIG. 6B, implementation of the SON functions in the NMS (610) and the EMSes (620) at the management entities (640) at the SMO (410) is shown.

FIG. 6C illustrates a third deployment scenario (600-C) where different SON algorithms are supported in multi-vendor EMS, in accordance with an embodiment of the present disclosure. In FIG. 6C, implementation of the SON functions in the EMS (620) associated with a first vendor and an EMS (630) associated with a second vendor at the SMO (410) is shown. In some embodiments, each EMS vendor (620, 630) may support different SON features and the performance of the E2 nodes (440) are directly associated with the vendor specific SON features. In an example embodiment, if the second EMS vendor (630) does not support SON features explicitly, the associated E2 node (440) may get the SON functionalities either from a Non-ORAN entity or through an internal mechanism associated with the management entity (640) to share SON features across the EMSes (620, 630) with and without SON support.

Referring to FIGS. 6A, 6B, and 6C the E2 node (440) and near-RT RIC (430) may not support the SON algorithms and it may be indicated in the SON capability to the SMO (410) over “SON support bitmap IE” via the O1 interfaces. The “SON support bitmap IE” is illustrated in FIG. 6D and will be discussed below in detail.

FIG. 6D illustrates a SON support bit map information element (IE) (600-D) in accordance with an embodiment of the present disclosure. In FIG. 6D different SON algorithms supported by a particular SON module in a bit map arrangement is shown. The various fields of the bit map IE include SON, a physical layer cell identity (PCI), an automatic neighbor relation (ANR), MLB, MRO, coverage and capacity optimization (CCO), energy saving(ES), interference mitigation between cluster (ICMI), computing component (COM), and seven reserved BITs.

Referring to FIG. 6D, SON support bitmap IE (600-D), in some embodiments when the bit-0 is set to ‘0’, it may indicate that SON Algorithms are not supported and rest of the bits in the bitmap are irrelevant. However, when the bit-0 is set to ‘1’, it may indicate that SON Algorithms are supported and rest of the bits in the bitmap indicates specific SON algorithms support. For example, bit-1 if it sets to ‘1’, indicates support for PCI selection and conflict resolutions algorithm support. Similarly, bit-2 is set to ‘1’, indicates its support for ANR algorithm support. Bit-3 indicates MLB support, Bit-4 indicates MRO support, Bit-5 indicates CCO support, Bit-6 indicates ES support, Bit-7 indicates ICIM support, and Bit-8 indicates COM support and rest of the bits may be reserved to include other SON features support in the future.

FIG. 6E illustrates a SON support matrix (600-E) associated with the deployment scenarios (600-A-600-C), in accordance with an embodiment of the present disclosure. In FIG. 6E, SON capability associated with different SON modules, for example, management entity (640) at SMO (410), non-RT RIC (420), near-RT RIC (430), and E2 node (440) as a SON support matric (600-E) is shown. The SON capability may be communicated by using SON support bit map IE.

FIG. 6F illustrates an exemplary sequence flow (600-F) for the SON support in accordance with the first, second and third deployment scenarios (600-A-600-C), in accordance with an embodiment of the present disclosure. In FIG. 6F, message sequences between different SON modules are shown.

In some embodiments, upon successfully establishing an O1 link, the Near-RT RIC (430) and the E2 nodes (440) may indicate their SON support capabilities via the message O1: Capability Update Indication, which may include their SON support bitmap details. Also, whenever the SON functions are enabled/disabled by the management entity (640) at the near-RT RIC (430) and/or E2 nodes (420), they will use this message to update their SON support capabilities. Further, upon receiving the capability information from near-RT RIC (430) and E2 node (440), the management entity (640) updates its Near-RT RIC database and/or E2 Node database according to the source of this received message. The management entity (640) may use this information to create or prepare the final SON support matrix. SON support matrix may include a decision indicating whose SON algorithms are going to be used for providing appropriate SON support.

Referring to FIG. 6F, at step 604, O1 link may be established between management entity (ME) (640) at SMO (410), near-RT RIC (430), and E2 nodes (440). Once the link is established, and when SON is enabled or disabled, at step 606, in near-RT RIC (430), the near RT-RIC (430) may send a capability update indication (608) comprising SON support bitmap associated with the near RT-RIC (430). The ME (640), at step 612, updates its near-RT RIC database to include the recent capability information shared by the near-RT RIC (430). Further, when SON is enabled or disabled, at step 614, in E2 node (420), the E2 node (420) may send a capability update indication (616) comprising SON support bitmap associated with the E2 node (440). The ME (640), at step 618, updates its E2 node database to include the recent capability information shared by the E2 node (440). Based on the received capability information, the ME (640), at step 622, decides on a final support matrix. The ME (640), at step 624, informs the final SON support matrix to near-RT RIC (430) and receives, at step 626, an acknowledgement from near-RT RIC (430). Further, the ME (640), at step 628, informs the final SON support matrix to the E2 node (440) and receives, at step 632, an acknowledgement from the E2-node (440). Upon completion of SON matrix communication, the ME (640) may, at step 634, prepare initial SON configuration and communicated the same to the near-RT RIC (430) and the E2 node (440) at steps 636, 638, respectively. Further, the ME (640), at step 642, may prepare dynamic SON configurations based on analytics data and events. The ME (640) may communicate the dynamic SON configuration to the near-RT RIC (430) and E2 node (440) at steps 644, 646, respectively. In some embodiments, the message communication between the ME (640), the near-RT RIC (430) and E2 node (440) may happen over O1 interface link.

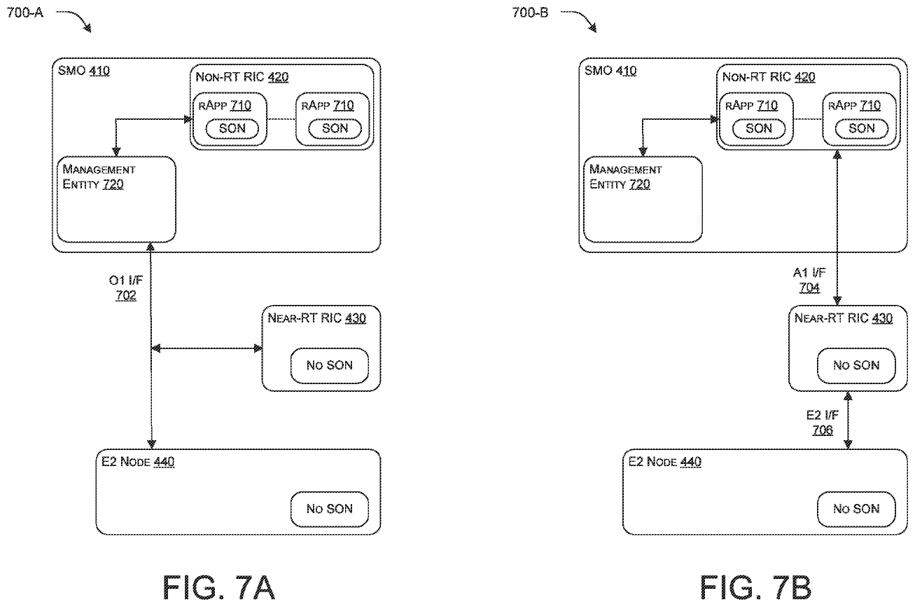

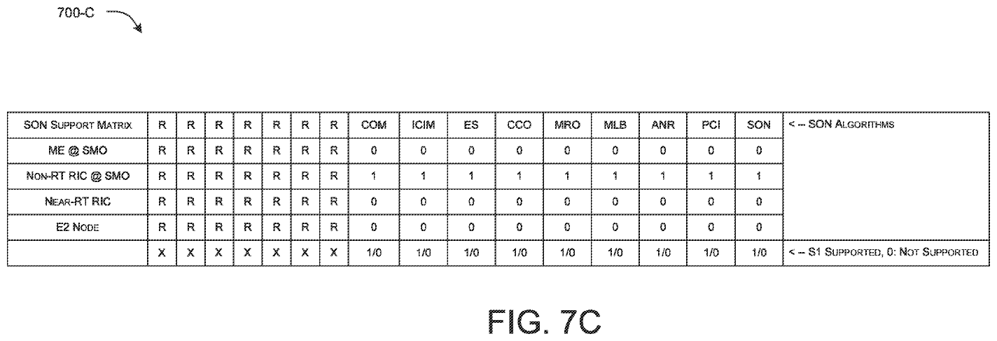

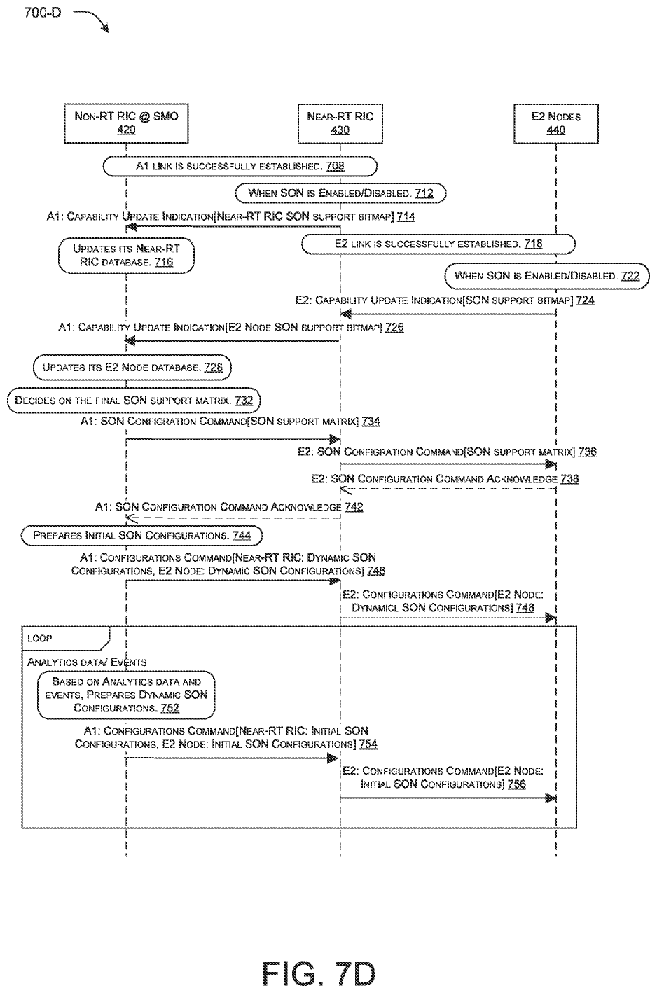

FIG. 7A illustrates an exemplary diagram representing a fourth deployment scenario (700-A) where SON algorithms are supported in a non-RT RIC using 01 interface, in accordance with an embodiment of the present disclosure. In FIG. 7A, implementation of the SON algorithm (710) at the non-RT RIC (420) as rApps, is shown. The SON algorithm (710) may communicate with the ME (720) using internal interfaces defined as part of SMO (410). The ME (720) may further communicate with near-RT RIC (430) and E2 nodes (440) via O1 interfaces. In some embodiments, the ME (720) may act as a master and receive the SON support capabilities from the non-RT RIC (420), near-RT RIC (430) and E2 nodes (440) and derives the SON support matrix and conveys a SON configuration information to non-RT RIC (420), near-RT RIC (430) and E2 nodes (440).

FIG. 7B illustrates an exemplary diagram representing a fifth deployment scenario (700-B) where SON algorithms are supported in a non-RT RIC using A1 and E2 interfaces, in accordance with an embodiment of the present disclosure. In FIG. 7B, the SON algorithm implemented in the non-RT RIC (420) as rApps communicating with the near-RT RIC via A1 interface (704) is shown. In some embodiments the non-RT RIC (420) may communicate with E2 node (440) via the near-RT RIC (430). For example, the non-RT RIC (420) implemented as rApps communicate with the near-RT RIC (430) via A1 interface (704) and the near-RT RIC (430) may further relay the SON data to the E2 nodes (440) via E2 interface (706).

FIG. 7C illustrates a SON support matrix (700-C) associated with the deployment scenarios (700-A-700-B), in accordance with an embodiment of the present disclosure. In FIG. 7C, the SON support matrix with non-RT RIC (420) implementing the SON function is shown. Only the bits (0-15) corresponding to the non-RT RIC (420) at the ME (640) are set to show that SON functions are implement only in non-RT RIC (420).

FIG. 7D illustrates an exemplary sequence flow (700-D) for the SON support in accordance with the fourth and fifth deployment scenarios (700-A-700-B), in accordance with an embodiment of the present disclosure. In FIG. 7D, the SON support messaging (700-D) associated with the SON implementation as discussed above with reference to FIGS. 7A and 7B is shown. Referring to FIG. 7D, at step 708, the A1 link is successfully established between non-RT RIC (420) at the SMO (410) and the near-RT RIC (430). Further at the near-RT RIC (430), at step 712, a SON algorithm may be enabled or disabled. Upon enabling/disabling the SON algorithm, the near-RT RIC (430), at step 714, may indicate their SON support capabilities via the message A1: Capability Update Indication, which includes near RT-RIC's SON support bitmap details. The non-RT RIC (420), at step 716, updates its near-RT RIC database. Similarly, at step 718, an E2 link may be established between the near-RT RIC (430) and the E2 node (440). Further, in step 722, a SON algorithm may be enabled/disabled at the E2 node (440). Upon enabling/disabling of the SON algorithm, the E2 node (440) at step 724, may indicate their SON support capabilities to near-RT RIC (430) via the message E2: Capability Update Indication, which includes E2 node's SON support bitmap details. The near-RT RIC (430), at step 726, may relay the message to the non-RT RIC (420) via the message A1: Capability Update Indication. Upon receiving the relayed message, the non-RT RIC (420), at step 726, may update its E2 node database. Also, whenever the SON functions are enabled/disabled by the ME (720) at the near-RT RIC (430) and/or E2 Nodes (440), they above discussed messages may be used to update their SON support capabilities.

Referring to FIG. 7D, the non-RT RIC (420) entity, at step 732, may prepare the final SON support matrix based at least on the messages received at steps 714, 726. The non-RT RIC (420), at step 734, may then communicate the final SON support matrix to the near-RT RIC (430). The near-RT RIC (430), at step 736, forwards the final SON support matric from the non-RT RIC (420) to the E2 nodes (440). The E2 node (440), at step 738, may send an acknowledgement message to the near-RT RIC (430). The near-RT RIC (430), at step 742, relays the acknowledgement message to the non-RT RIC (420). Upon receiving the acknowledgement message, the non-RT RIC (420), at step 744, prepares an initial SON configuration. The non-RT RIC (420), at step 746, communicates the initial SON configuration to the near-RT RIC (430), wherein the communication includes the initial SON configuration associated with the near-RT RIC (430) and the initial SON configuration associated with the E2 node (440). The near-RT RIC (430), at step 748, further relays the initial SON configuration associated with the E2 node (440) to the E2 node.

Referring to FIG. 7D, based on the analytics data patterns and also based on some recent events, the non-RT RIC (420), at step 752, may generate dynamic SON configurations. The non-RT RIC (420) may then convey the dynamic SON configurations in a manner similar to the above discussed steps of conveying an initial SON configuration. The non-RT RIC (420), at step 754, sends the message A1: configurations command with near-RT RIC: dynamic SON configurations and E2 Node: dynamic SON configurations, to the near-RT RIC, which, at step 756, further relays the E2 Node: Dynamic SON configurations to the E2 Node (440) via E2: Configurations Command message.

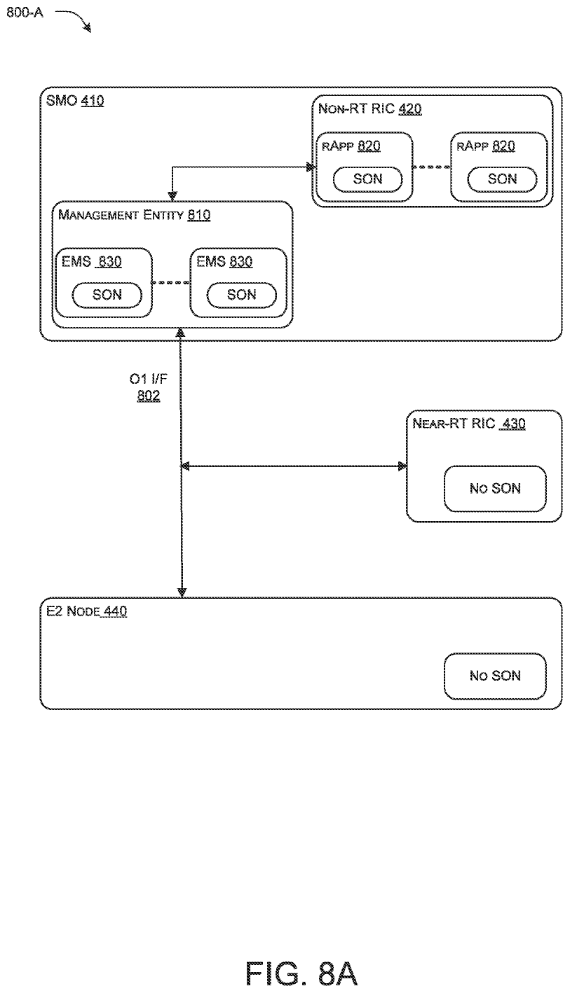

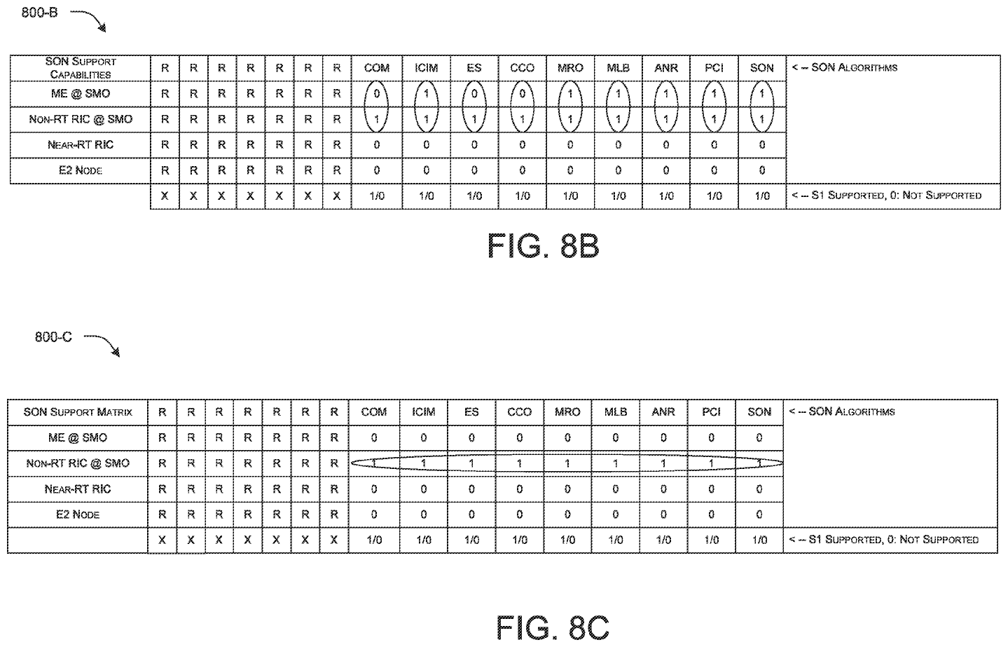

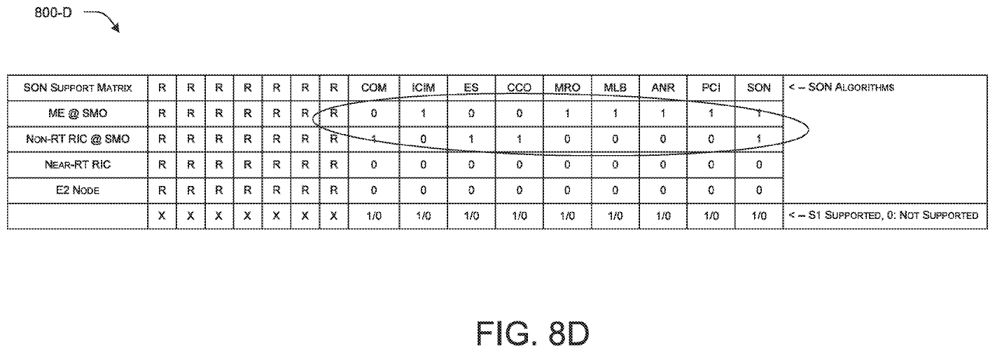

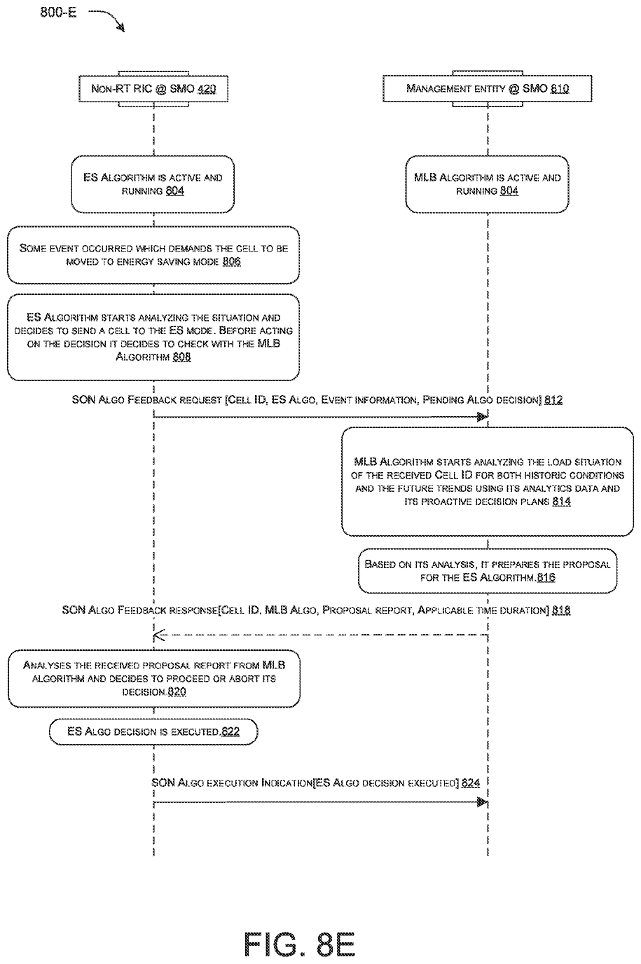

FIG. 8A illustrates an exemplary diagram representing a sixth deployment scenario (800-A) where SON algorithms are supported in both management entity as well as in non-RT RIC using O1 interface, in accordance with an embodiment of the present disclosure. In FIG. 8A. SON algorithm supported at both ME (810) and non-RT RIC (420) are shown. In some embodiments, the non-RT RIC (420) may be associated with a first vendor and support one version of the SON algorithms and the ME (810) may be associated with a second vendor and support another version of the SON algorithms, wherein both the first and second vendors may or may not support complete list of SON functionalities.

FIGS. 8B-8D illustrate SON support matrices associate with the deployment scenario (800-A), in accordance with an embodiment of the present disclosure. In FIG. 8B, the SON capabilities associated with the ME (810), the non-RT RIC (420), the near-RT RIC (430), and the E2 node (440) are shown. Referring to FIG. 8B, the ME (810) and the non-RT RIC (420) support SON algorithm. In some embodiments, the ME (810) supports ICIM, MRO, MLB, ANR, and PCI functionalities and the non-RT RIC (420) supports COM, ICIM, ES, CCO, MRO, MLB, ANR, PCI, SON functionalities. In an exemplary embodiment, the ME (810), being a master, may have an option to choose the best SON functionalities between the set of SON functionalities supported by the ME (810) and the non-RT RIC (420). Accordingly, the ME (810) may initially choose all the best SON functionalities as implemented by the non-RT RIC (420) as shown in the SON support matrix of FIG. 8C. The ME (810) may further communicate the selected SON support matrix to other entities, for example, the non-RT RIC (420), the near-RT RIC (430), and the E2 node (440), by one or more ways as discussed above. However, the ME (810) may start collecting statistics associated with the applied SON functionalities over a period of time under different conditions and may decide to revise the SON support matrix. In some embodiments, the ME (810) may choose SON functionalities from multiple entities to improve the overall performance of the HetNet. For example, FIG. 8D illustrates the new SON support matrix decided by the ME (810). Referring to FIG. 8D, in the new SON support matrix (800-D), the ME (810) has chosen SON algorithms from both the ME (810) and non-RT RIC (420). Accordingly, the SON algorithms like PCI, ANR, MLB, MRO and ICIM are chosen from the ME (810) and the SON algorithms like CCO, ES and COM are chosen from the non-RT RIC (420). Further, since the chosen set of algorithms are from different vendors and may run in different locations, for example, may be or may not be from different geographies, they may need some coordination among them. In some embodiments, the ES from the non-RT RIC (420) may need to coordinate with MLB algorithms from the ME (810) to take its final decision on going to energy saving mode or not. In general, the MLB algorithms know the pattern of the cell load and based on the analytics data the MLB algorithm may plan to offload some of the cell data. In an exemplary embodiment, considering the case of cells C1, C2, C3. . . . Cn, the MLB may sense cell overload in C1, C2 and may plan to offload some of the cell data associated with C1 and C2 to a neighboring cell C3. However, if the ES plans energy saving mode for cell C3, then C3 will go to a sleep mode and when MLB performs offloading for C3, it may get active again. This might create a ping-pong effect at C3. Therefore, to avoid such problems, the ES needs to coordinate with the MLB. In other words, when one or more SON functionalities are used across different modules, they need to be coordinated to avoid problems.

FIG. 8E illustrates an exemplary sequence flow (800-E) for the SON support in accordance with the sixth deployment scenario (800-A), in accordance with an embodiment of the present disclosure. In FIG. 8E, coordination between different SON algorithms implemented on different entities is shown. Referring to FIG. 8, at step 804, the ES algorithm may be running on the non-RT RIC (420) and the MLB algorithm may be running on the ME (810). Further, the non-RT RIC (420) may, at step 806, detect a set of events demanding a particular cell to move to an energy saving state. Upon detecting the set of events, the ES at the non-RT RIC (420), at step 808, decides to send the particular cell to a sleep mode, however, the ES sends a message to the ME (810) to check with the MLB algorithm before sending the particular cell to the sleep mode. The ES at the non-RT RIC (420) may initiate, at step 812, a SON algo feedback request comprising at least one of cell Identity (cell ID), ES algorithm (ES algo), an event information, and a pending algorithm decision (pending algo decision), to the MLB at the ME (810). The MLB at the ME (810), at step 814, may analyze the load situation for the received cell ID based on both historic condition and future trends and prepares, at step 816, a proposal response to be sent to the ES at the non-RT RIC (420). The MLB at the ME (810), at step 818, may send SON algorithm feedback response comprising at least one of cell ID, MLB algo, proposal report, applicable time duration, etc. The ES at the non-RT RIC (420), at step 820, may analyze the received report and decides to procced or abort the initiated action based on the received report. The ES at the non-RT RIC (420), at step 822, may execute its decision. Further, the ES at the non-RT RIC (420), at step 824, may indicate its execution to the MLB at the ME (810), wherein the indication includes ES algo decision executed status. The communication between different SONs implemented in different entities may enable proper working.

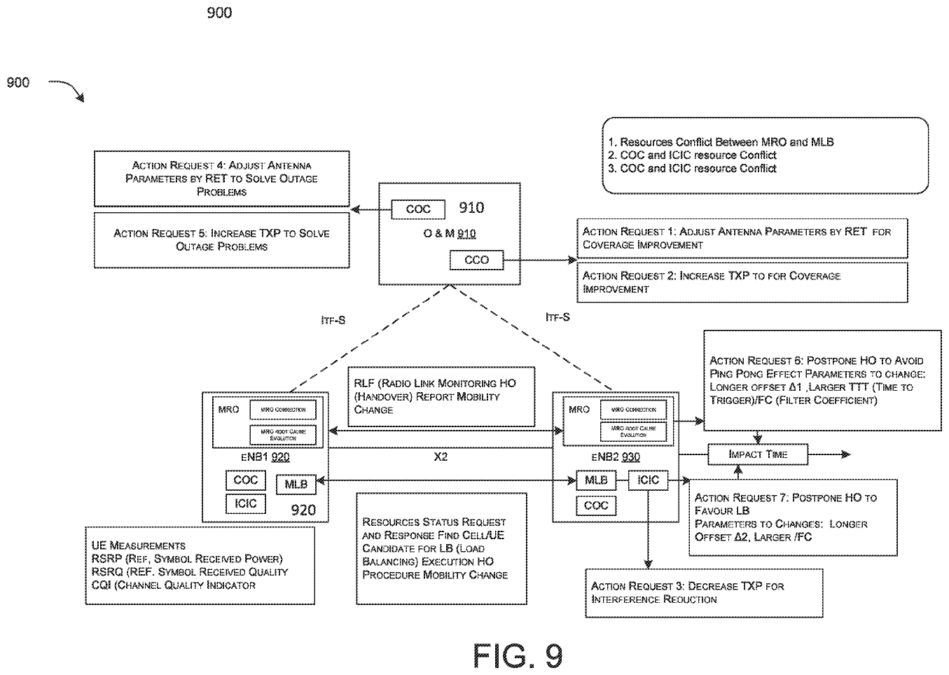

FIG. 9 illustrates an exemplary representation (900) of possible interference in the HetNet due to interaction between multiple SON functions, in accordance with an embodiment of the present disclosure. In FIG. 9, conflicts that may be created in the HetNet due to optimization by SON implementation is shown. In some embodiments, when two or more SON functions aim at optimizing the same output parameter, there exists a possibility of one or more conflicts for examples:
A resource conflict between MRO and MLB.
A conflict between CCO and intercell interference coordination (ICIC).
A conflict between cell outage compensation (COC) and ICIC.

Referring to FIG. 9, the MRO may be associated with eNodeB (eNB1) (920) and the MLB may be associated with eNB2 (930). The conflict of handover may occur between the MRO and MLB. In some embodiments, the COC associated with operation and maintenance node (O&M) (910) may try to increase a transmit power to solve outage problem, however, the ICIC associated with eNB2 (930) may try to reduce the transmit power for reducing interference. This may lead to a conflict. Similarly, the CCO associated with operation and maintenance node (O&M) (910) may try to adjust the antenna parameters for coverage improvement, however, the ICIC may try to reduce the transmit power resulting in a conflict. Hence, by applying coordination techniques as mentioned above with reference to FIG. 8D, such conflicts may be avoided in the SON implementation.

A person of ordinary skill in the art will appreciate that these are mere examples, and in no way, limit the scope of the present disclosure.

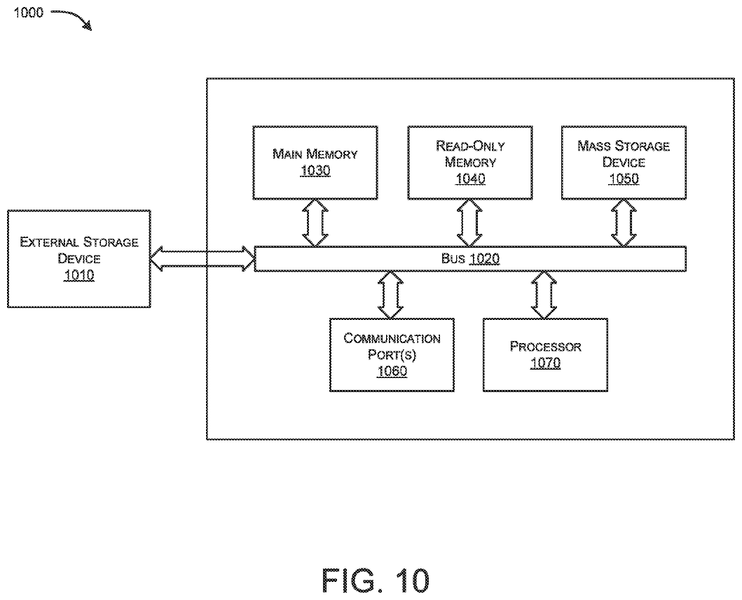

FIG. 10 illustrates an exemplary computer system (1000) in which or with which embodiments of the present disclosure may be utilized. As shown in FIG. 10, the computer system (1000) may include an external storage device (1010), a bus (1020), a main memory (1030), a read-only memory (1040), a mass storage device (1050), communication port(s) (1060), and a processor (1070). A person skilled in the art will appreciate that the computer system (1000) may include more than one processor and communication ports. The processor (1070) may include various modules associated with embodiments of the present disclosure. The communication port(s) (1060) may be any of an RS-232 port for use with a modem-based dialup connection, a 10/100 Ethernet port, a Gigabit or 10 Gigabit port using copper or fiber, a serial port, a parallel port, or other existing or future ports. The communication port(s) (1060) may be chosen depending on a network, such a Local Area Network (LAN), Wide Area Network (WAN), or any network to which the computer system (1000) connects. The main memory (1030) may be random access memory (RAM), or any other dynamic storage device commonly known in the art. The read-only memory (1040) may be any static storage device(s) including, but not limited to, a Programmable Read Only

Memory (PROM) chips for storing static information e.g., start-up or basic input/output system (BIOS) instructions for the processor (1070). The mass storage device (1050) may be any current or future mass storage solution, which may be used to store information and/or instructions.

The bus (1020) communicatively couples the processor (1070) with the other memory, storage, and communication blocks. The bus (1020) can be, e.g. a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor (1070) to the computer system (1000).

Optionally, operator and administrative interfaces, e.g. a display, keyboard, and a cursor control device, may also be coupled to the bus (1020) to support direct operator interaction with the computer system (1000). Other operator and administrative interfaces may be provided through network connections connected through the communication port(s) (1060). In no way should the aforementioned exemplary computer system (1000) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter to be implemented merely as illustrative of the disclosure and not as limitation.

### ADVANTAGES OF THE PRESENT DISCLOSURE

The present disclosure provides interoperability techniques between SON functions implemented by one or more vendors.

The present disclosure provides a master slave architecture for discovery and handshake between the different entities enabling better implementation of the SON procedure.

The present disclosure provides an advanced communication system.

We claim:

1. A system (202) for enabling interoperability of self-organizing networks (SONs) in a heterogeneous network (HetNet) (100), the system (202) comprising:
one or more processors (302); and
a memory (304) operatively coupled to the one or more processors (302), wherein the memory (304) comprises processor-executable instructions, which on execution, cause the one or more processors (302) to:
send a SON capability query (404-a, 404-b, 404-c) to one or more entities in the HetNet (100);
receive a SON capability information (406-a, 406-b, 406-c) associated with the one or more entities in the HetNet (100) in response to the SON capability query (404-a, 404-b, 404-c); and
generate an initial SON configuration associated with the one or more entities based on the received SON capability information.

2. The system (202) as claimed in claim 1, wherein the memory (304) comprises processor-executable instructions, which on execution, cause the one or more processors (302) to:
command the one or more entities in the HetNet (100) to enable the SON function in the one or more entities based on the received SON capability information.

3. The system (202) as claimed in claim 1, wherein the memory (304) comprises processor-executable instructions, which on execution, cause the one or more processors (302) to:
command the one or more entities in the HetNet (100) to disable the SON function in the one or more entities based on the received SON capability information.

4. The system (202) as claimed in claim 1, wherein the one or more entities comprise open radio access network (O-RAN) entities.

5. The system (202) as claimed in claim 4, wherein the one or more entities comprise at least one of: a non-real time radio access network intelligent controller (non-RT RIC) (420), a near-RT RIC (430), and an E2 node (440).

6. The system (202) as claimed in claim 1, wherein the SON capability information comprises an SON support bitmap information element (IE).

7. The system (202) as claimed in claim 6, wherein the memory (304) comprises processor-executable instructions, which on execution, cause the one or more processors (302) to:
create an SON support matrix based on the SON support bitmap IE received from the one or more entities; and
generate the initial SON configuration based on the SON support matrix.

8. The system (202) as claimed in claim 7, wherein the memory (304) comprises processor-executable instructions, which on execution, cause the one or more processors (302) to:
collect analytics data associated with the HetNet (100);
detect one or more events in the HetNet (100); and
generate a dynamic SON configuration associated with the one or more entities based on at least one of the collected data and the detected one or more events.

9. The system (202) as claimed in claim 7, wherein the memory (304) comprises processor-executable instructions, which on execution, cause the one or more processors (302) to:
operate a first element associated with the SON configuration in a first entity of the one or more entities;
operate a second element associated with the SON configuration in a second entity of the one or more entities;
detect a change of operation associated with the first element in the first entity; and
communicate the change of operation associated with the first element in the first entity to the second element in the second entity.

10. The system (202) as claimed in claim 9, wherein the memory (304) comprises processor-executable instructions, which on execution, cause the one or more processors (302) to:
receive a response from the second element in the second entity based on the change of operation associated with the first element in the first entity; and
execute the change of operation associated with the first element in the first entity based on the received response.

11. A method for enabling interoperability of self-organizing networks (SONs) in a heterogeneous network (HetNet) (100) comprising:
sending, by one or more processors (302), a SON capability query (404-a, 404-b, 404-c) to one or more entities in the HetNet (100);
receiving, by the one or more processors (302), a SON capability information (406-a, 406-b, 406-c) associated with the one or more entities in the HetNet (100) in response to the SON capability query (404-a, 404-b, 404-c); and
generating, by the one or more processors (302), an initial SON configuration based on the received SON capability information.

12. The method as claimed in claim 11, comprising:
commanding, by the one or more processors (302), the one or more entities in the HetNet (100) to enable the SON function in the one or more entities based on the received SON capability information.

13. The method as claimed in claim 11, comprising:
commanding, by the one or more processors (302), the one or more entities in the HetNet (100) to disable the SON function in the one or more entities based on the received SON capability information.

14. The method as claimed in claim 11, wherein the one or more entities comprises open radio access network (O-RAN) entities.

15. The method as claimed in claim 14, wherein the one or more entities comprises at least one of a non-real time radio access network intelligent controller (non-RT RIC) (420), a near-RT RIC (430), and a E2 node (440).

16. The method as claimed in claim 11, wherein the SON capability information comprises a SON support bitmap information element (IE).

17. The method as claimed in claim 16, comprising:
creating, by the one or more processors (302), a SON support matrix based on the SON support bitmap IE from the one or more entities; and
generating, by the one or more processors (302), the initial SON configuration based on the SON support matrix.

18. The method as claimed in claim 17, comprising:
collecting, by the one or more processors (302), analytics data associated with the HetNet (100);
detecting, by the one or more processors (302), one or more events in the HetNet (100); and
generating, by the one or more processors (302), a dynamic SON configuration associated with the one or more entities based on at least one of the collected data and the detected events.

19. The method as claimed in claim 17, comprising:
operating, by the one or more processors (302), a first element associated with the SON configuration in a first entity of the one or more entities;
operating, by the one or more processors (302), a second element associated with the SON configuration in a second entity of the one or more entities;
detecting, by the one or more processors (302), a change of operation associated with the first element in the first entity; and
communicating, by the one or more processors (302), the change of operation associated with the first element in the first entity to the second element in the second entity.

20. The method as claimed in claim 19, comprising:
receiving, by the one or more processors (302), a response from the second element in the second entity based on the change of operation associated with the first element in the first entity; and
executing, by the one or more processors (302), the change of operation associated with the first element in the first entity based on the received response.

21. A user equipment (UE) operating in a heterogenous network (HetNet), the UE comprising:
one or more processors communicatively coupled to a system (202), wherein the system (202) comprises one or more processors (302) and a memory (304) operatively coupled to the one or more processors (302), wherein the memory comprises processor-executable instructions, which when executed by the one or more processors (302), cause the one or more processors (302) to:
send a self-organizing network (SON) capability query (404-a, 404-b, 404-c) to one or more entities in the HetNet (100);
receive a SON capability information (406-a, 406-b, 406-c) associated with the one or more entities in the HetNet (100) in response to the SON capability query (404-a, 404-b, 404-c); and
generate an initial SON configuration associated with the one or more entities based on the received SON capability information.

22. A non-transitory computer readable medium comprising one or more instructions stored thereupon that when executed by a processor cause the processor to:
send a self-organizing network (SON) capability query (404-a, 404-b, 404-c) to one or more entities in the HetNet (100);
receive a SON capability information (406-a, 406-b, 406-c) associated with the one or more entities in the HetNet (100) in response to the SON capability query (404-a, 404-b, 404-c); and
generate an initial SON configuration associated with the one or more entities based on the received SON capability information.
